(19) United States
(12) Patent Application Publication
(10) Pub. No.: US 2007/0095872 A1
(43) Pub. Date: May 3, 2007

(54) Convertible caddy for pets for a bicycle or satchel transport

(76) Inventors: Brad White, Marshfield Hills, MA (US); Julie Anne White, Marshfield Hills, MA (US); Dominic White, Marshfield Hills, MA (US)

Correspondence Address: Joseph L. Strabala, Esq.;Law Office of Joseph L. Strabala, Suite 1020, One Embarcadero Center, San Francisco, CA, 94111, US

(21) Appl. No.: 11/542,981

(22) Filed: Oct. 4, 2006

Related U.S. Application Data
(60) Provisional application No. 60/723,797, filed on Oct. 5, 2005.

(51) Int. Cl. B62J 7/06; B62J 9/00

(52) U.S. Cl. 224/420; 224/437

(57) ABSTRACT

According to the invention the pet caddy has a substantially flat bottom, a soft side wall extending from the bottom to an open top encircled with a rim structure to maintain an opening at the toe, with two integral brackets adjacent to the top arranged to clamp around the bicycle handlebars to support the caddy with a removable strut secured to the bottom and extending to neck of the handle bars to support the caddy in a vertical position, plus a strap located on the inside surface of the wall for connecting a short leash to restrain a pet while in the caddy. Handles are connected to the wall so that the caddy can be carried like a satchel without removing a pet. Removable padding inserted on the bottom enclosure of the housing creates a more comfortable environment for the pet and can be removed and replaced if soiled. The base of wall also has a plurality of ventilation ports for air circulation.

This application claims the priority and benefits of Provisional Patent Application Ser. No. 60/723,797 filed on Oct. 5, 2005 by these inventors.

This invention relates to a pet carrier for use on a bicycle or as a satchel. In particular, the invention relates to a pet caddy for small animals that can be mounted on the handlebars of a bicycle or used as a satchel to carry a pet.

### THE PRIOR ART

When traveling by bicycle it is often desirable to bring one's pet along. Thus there are pet carriers for bicycles so that small pets, such as small dogs, can travel with the owner when the owner is on a bicycle.

U.S. Pat. No. 5,577,646 to White discloses a pet carrier for a bicycle that is attached to a frame that is affixed over the rear wheel of a bicycle. Another such pet carrier is disclosed in U.S. Pat. No. 5,832,874 to Ravin U.S. Pat. No. Des. 276,713 to Schacter discloses another similar pet carrier.

Various baskets for the front of a bicycle are disclosed in U.S. Pat. No. 530,160 to Coulson and U.S. Pat. No. 482,938 to Blood.

Pet carriers for automobiles are shown in U.S. Pat. No. 4,010,880 to Guillot-Munoz and U.S. Pat. No. 5,785,003 to Jacobson et al.

U.S. Pat. No. 6,425,349 issued to Laskin, et al. teaches a bracket for the front of a bicycle that receives a basket for transporting a small pet on the front of a bicycle so the pet is in full view of the rider and secured by a harness.

An object of the invention is to provide a pet carrier that safely and comfortably transports a small pet on the front of a bicycle and/or can be used as a satchel to transport a small pet.

Another object of the invention to provide a pet carrier that is simple and quick for consumers to attach to their bicycles.

Also an object of the invention to provide a front-mounted pet carrier in which the pet is always in full view of the bicycle rider which is preferable to rear-mounted carriers in which the pet is riding behind the rider, so the condition of the pet cannot be monitored.

Other objects and advantages will be apparent from the description and the drawings of this invention.

### SUMMARY OF THE INVENTION

According to the invention the pet caddy has a substantially flat bottom, a soft side wall extending from the bottom to an open top, with two integral brackets adjacent to the top arranged to clamp around the bicycle handlebars to support the housing with a removable strut secured to the bottom and extending to neck of the handle bars to support the caddy in a vertical position, plus a strap located on the inside surface of the wall for connecting a short leash to restrain a pet. Handles are connected to the wall so that the caddy can be carried like a satchel and further straps are connected to the wall so that the caddy can be transported as a backpack. Removable padding inserted on the bottom enclosure of the housing creates a more comfortable environment for the pet and can be removed and replaced if soiled. The wall also has a plurality of ventilation ports therein adjacent to the base to allow air to pass into the interior of the caddy.

Small dogs, such as the Maltese, Coton de Tulears, West Highland Terrier and Chihuahua, can be transported in the caddy as well as cats.

An optional removable canopy connected to the caddy in an arrangement that covers the top opening of the caddy protects a pet inside from the elements when employed.

### DESCRIPTION OF THE DRAWINGS

FIG. 1 is a perspective of the novel pet caddy of this invention;

FIG. 2 is a top view of the pet caddy shown in FIG. 1;

FIG. 3 is an elevation of the pet caddy shown in FIG. 1;

FIG. 4 is an elevation of the removable strut that hold the caddy vertical;

FIG. 5 is a perspective of the optional canopy for the caddy to protect a pet from the elements; and

FIG. 6 is an elevation of the caddy folded for storage.

### DESCRIPTION OF AN EMBODIMENT

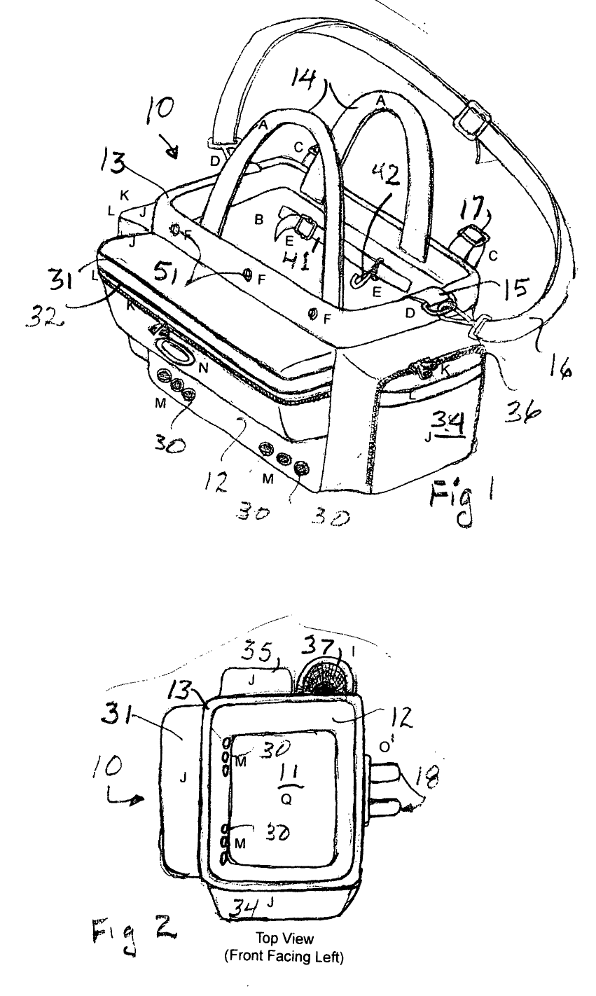

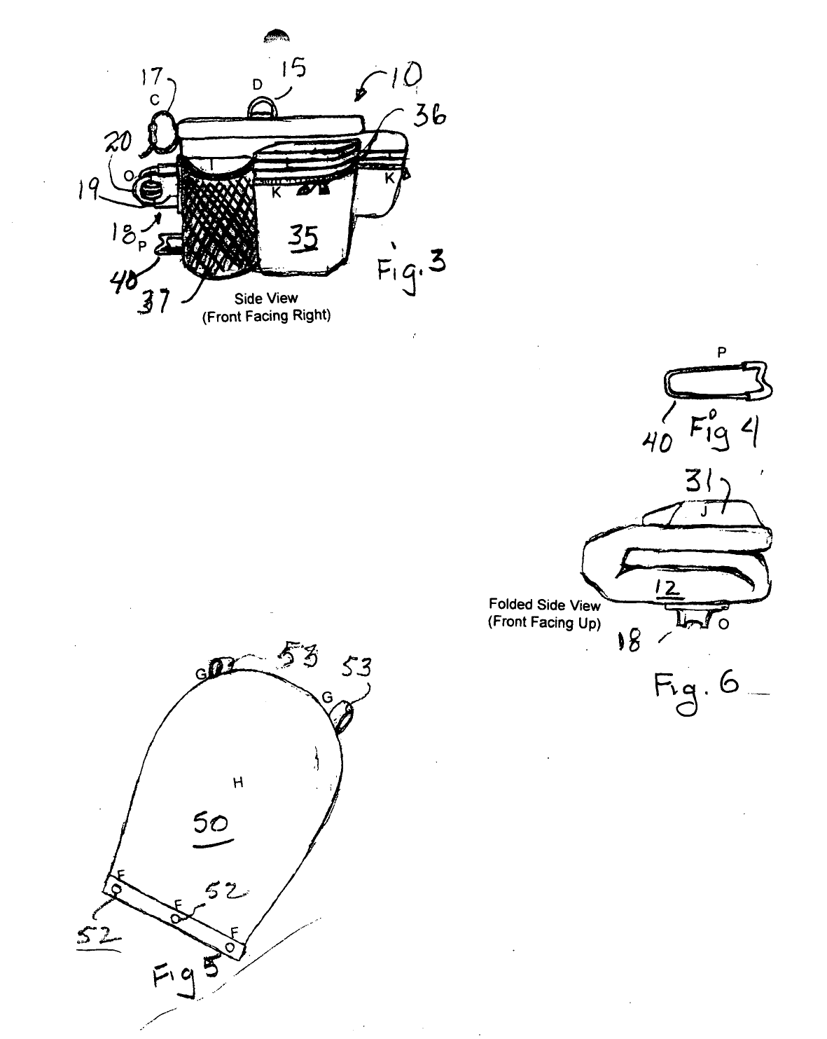

The novel sport caddy 10 is best shown in FIGS. 1 and 2. It includes a bottom panel 11 (see FIG. 2) encircled by a fabric wall 12 that extends to the top rim 13 of the caddy to form a basket like enclosure which is open at the top. Typically the fabric is stiff enough to maintain the described basket configuration when assembled between the bottom and the rim. This rim is reinforced so that it maintains a rectangular opening at the top of the caddy and forms a support structure for attaching a pair of handles 14 and strap rings 15 through which a shoulder strap 16 can be attached. In addition the rim structure includes spaced apart loops 17 which can be opened and closed to attach the rim structure to the handle bars of a bicycle. An alternative attachment 18 shown in FIGS. 2 and 3 includes a pair of spaced apart sockets 19 mounted on a plate adjacent to the rim that receives u-shaped members 20 that are placed on the handle bars of a bicycle and inserted into the sockets in the caddy to retain the caddy on the handle bars.

As can be seen in FIG. 1 the fabric 12 forming the generally vertical wall has ventilation ports 30 adjacent to its connection to the bottom of the caddy. On the opposite side of the loops 17, a compartment 31, a cargo pocket, can be mounted just below the rim and equipped with a zipper 32 so that pet supplies can be carried with the caddy. It is one of serval pockets, see pockets 34 and 35, in the novel caddy and enables the storage of leashes, cell phones, sun glasses, keys and similar items while biking. Further a reflective horizontal band or strip 33 is secured to the outside of the compartment to provide a visual cue to other vehicles.

Additional pockets 34 and 35 can be affixed to the wall 12 at both ends of the caddy and closed with zippers 36. These additional pockets can also have a horizontal reflecting band thereon like the band on compartment 31. Further as can be seen in FIG. 3 a mesh bottle holder 37 is provided at one end of the caddy 10 which constructed of a stretchable netting so that it can accept various size bottles.

In order to keep the caddy 10 in a vertical position, a removable strut 40 shown in FIG. 4 is attached to the bottom 11 of the caddy and extends to the journal (post for the fork) for the handlebars so that the bottom of the caddy is supported in a manner that will keep the fabric wall the caddy vertical distal end of the strut has an arcuate bearing surface that tracks on the journal when the handle bars are manipulated. The strut is removable and can be placed in one of the pockets when not in use.

As can seen in FIG. 1 there is an elongated strap 41 with a traveling ring 42 thereon located just below the rim 13 with connections on the opposite side to loops 17. A short leash can be connected between the ring and a collar of the pet in the caddy, insures the pet will not unexpectedly exit the caddy while so secured but allows the pet increased mobility when in the caddy.

It can be appreciated, that if the caddy 10 is removed from the handlebars of a bicycle, a pet in the caddy can be transported using the straps 14 without removing the pet. Likewise, the shoulder strap 16, typically stored in one of the pockets, can be removed and employed to transport the pet without removing the pet from the caddy.

If inclement weather is encountered when the caddy 10 is mounted on the handlebars of a bicycle, a canopy 50 shown in FIG. 5 can be attached to fasteners 51 on the rim 13 with cooperating fasteners 52 on the canopy so the latter can be placed over the caddy and secured to the handlebars of the bicycle with spaced apart connecting loops 53 which can be opened and closed using buckles or Velcro® fastening devices. The canopy also functions as sun shade for pets if desired.

Having described our invention we claim:

1. A convertible pet caddy for use on a bicycle and as a satchel comprising:
a bottom panel means operable to form the bottom of the caddy;
a rim means having stiffening means operable to form a support for the opening in top of said caddy;
a fabric wall means encircling said bottom panel means and extending upwards to and connected to said rim means operable to form an encircling vertical wall of said caddy;
flexible handle means connected to said rim means operable to support said caddy through said handle means; and
spaced apart connecting means associated with said rim means operable to secure said caddy to the handlebars of a bicycle.

2. A convertible pet caddy for use on a bicycle defined in claim 1 wherein the rim means includes attachments for connecting a shoulder strap and a shoulder strap is connected to said attachments operable to support said caddy on the shoulder of a user through said strap means.

3. A convertible pet caddy for use on a bicycle and as a satchel defined in claim 1 wherein the fabric wall has vents adjacent to the bottom panel to enable air circulation through the caddy.

4. A convertible pet caddy for use on a bicycle and as a satchel defined in claim 1 wherein a horizontal strap means is connected below the rim and a traveler with a leash attachment which is slidably mounted thereon for connecting a short leash of a pet in the caddy so that such pet can have increase mobility when in the caddy.

5. A convertible pet caddy for use on a bicycle and as a satchel defined in claim 1 wherein a canopy means is operable to cover the top opening of the caddy by attaching means connecting it to the rim means and loop means operable to attach it to the handle bars of bicycle so that it is secured across such opening.

6. A convertible pet caddy for use on a bicycle and as a satchel defined in claim 1 wherein at last one closeable pocket is attached to its exterior surface.
